(19) United States
(12) Patent Application Publication
(10) Pub. No.: US 2003/0079304 A1
(43) Pub. Date: May 1, 2003

(54) Toothbrush with vibrating head

(76) Inventor: William S. Dworzan, Santa Ana, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/189,632

(22) Filed: Jul. 5, 2002

Related U.S. Application Data
(60) Provisional application No. 60/340,557, filed on Oct. 30, 2001.

(51) Int. Cl. A61C 17/22

(52) U.S. Cl. 15/22.1

(57) ABSTRACT

Toothbrushes that utilize a rotating eccentric weight positioned in or near the head of the toothbrush to cause movement of the head, and methods relating to same.

This application claims the benefit of U.S. provisional application No. 60/340,557 filed on Oct. 30, 2001 and titled “Disposable Electric Toothbrush” incorporated herein by reference in its entirety.

FIELD OF THE INVENTION

The field of the invention is electric toothbrushes.

### BACKGROUND OF THE INVENTION

The benefits of electric toothbrushes are well known. One type of electric toothbrush utilizes an eccentrically moveable weight (by coupling an eccentric weight to a rotating motor) shaft to cause a handle of the toothbrush to vibrate, the vibration of the handle being transmitted to the bristles of the brush via a neck coupling the bristle portion/head of the brush to the handle. The use of such devices is not always desirable however, at least in part because of the relatively large amount of vibration required in the handle in order to get an acceptable amount of vibration of the bristles, and the corresponding cost in energy and high degree of vibration transferred to the hand of someone using such a brush. Example of such prior art toothbrushes can be found in U.S. Pat. Nos. 3,685,080, 5,421,726, 5,651,157, 5,706,542, 5,718,667, and 5,706,542. An eccentric weight, as the term is used herein, is a moveable weight that does not rotate about an axis that passing through the center of mass of the weight. Such a weight may or may not be symmetrical about an axis, but, if mounted to a rotating shaft, is not symmetrical (at least in regard to mass distribution) about the shaft.

Unfortunately, current toothbrushes are constructed in a manner that raises the cost of such toothbrushes beyond the reach of many people. Moreover, such toothbrushes are unduly cumbersome because of their weight, and size, and/or because of the battery charger that is used to recharge them. Thus, there is-a continuing need for affordable electric toothbrushes that are not unduly cumbersome.

### SUMMARY OF THE INVENTION

The present invention is directed to toothbrushes that utilize a rotating eccentric weight positioned in or near the head of the toothbrush to cause movement of the head relative to a handle of the toothbrush, and methods relating to same. Positioning the weight in or near the head allows production of toothbrushes having numerous advantages over convention toothbrushes and powered toothbrushes including but not necessarily limited to: (a) use of a relatively low power motor to rotate the weight; (b) lighter weight; (c) reduced handled vibration; (d) longer battery life; (e) higher reliability; and/or (f) disposability. The phrase “near the head” is used herein to indicate that the weight is at least closer to the head than to the body/handle, preferably separated from the head by a distance less than half the distance separating it from the body.

Disposable embodiments are possible as the use of a low power motor permits the toothbrush to go for long periods without recharging its batteries. Obtaining long periods of use without recharging permits a single battery or set of batteries to last as long as the bristles of the brush. The use of a lower power motor, a simple movement mechanism, non-rechargeable batteries, and non-replaceable bristles permits the total cost of the brush to be brought to a level where it is reasonable to dispose of the toothbrush after the bristles and/or batteries wear out. Making the toothbrush disposable permits the batteries to be permanently sealed inside the toothbrush which in turn increases safety while reducing manufacturing costs.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a view of a first toothbrush embodying the invention.

FIG. 2 is a detail view of the motion of a weight positioned within the head of the toothbrush of FIG. 1.

FIG. 3A is a detail view of the motion of the head of the toothbrush of FIG. 1 for embodiments where the motion is circular/orbital.

FIG. 3B is a detail view of the motion of the head of the toothbrush of FIG. 1 for embodiments where the motion is vertical.

FIG. 3C is a detail view of the motion of the head of the toothbrush of FIG. 1 for embodiments where the motion is horizontal.

FIG. 4 is a view of a second toothbrush embodying the invention.

### DETAILED DESCRIPTION

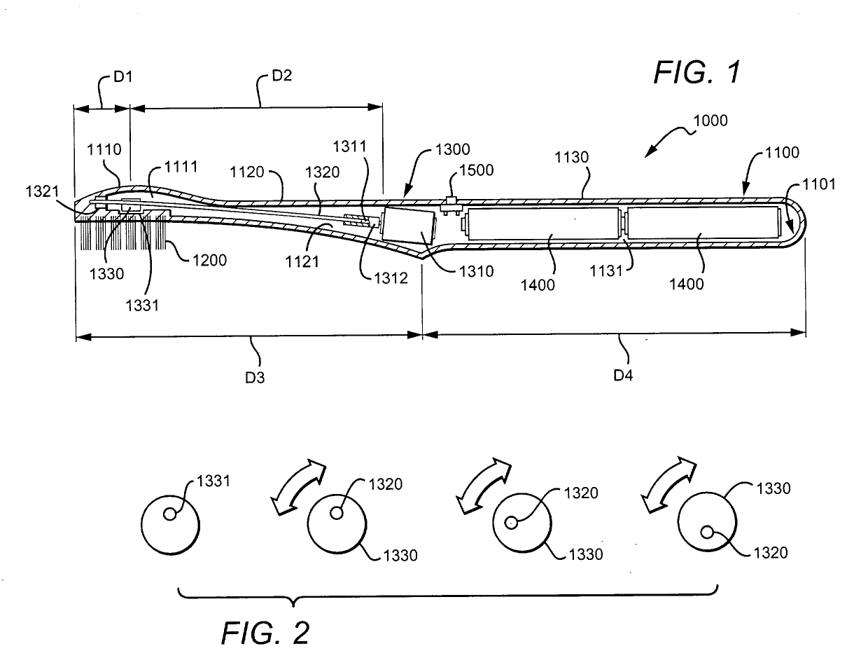

Referring first to FIG. 1, toothbrush 1000 comprises body 1100, bristles 1200, motion assembly 1300, power source(s) 1400, and control assembly 1500.

Body 1100 comprises head 1110, neck 1120, and handle 1130. Head 1110 is the portion of body 1100 to which bristles 1200 are mounted. Neck 1120 is the portion of body 1100 that couples head 1110 to handle 1130. Handle 1130 is the portion of body 1100 that is adapted to be gripped by someone using toothbrush 1000. Body 1100 also comprises body cavity 1101 that is subdivided into cavities corresponding to head 1110, neck 1120, and handle 1130. The sub-cavities of body cavity 1101 are head cavity 1111, neck cavity 1121, and handle cavity 1131. Motion assembly 1300 comprises motor 1310, motor spindle 1311, coupler 1312, flexible wire shaft 1320, shaft bearing 1321, weight 1330, and weight well 1331. Power source 1400 comprises two AAA batteries. Control assembly 1500 comprises the switches and circuitry used to control the movement of weight 1330 by controlling the use of motor 1310.

Distance D1 is the distance from the tip toothbrush 1000 to the center of mass of weight 1330. Distance D2 is the distance from the center of mass of weight 1330 to motor 1310. Distance D3 is the total length of the head 1110 and neck 1120 portions of body 1100. Distance D4 is the length of handle 1130.

Body 1100 is preferably formed a plurality of molded plastic pieces, the pieces coupled together in a manner which hermetically seals the body cavity 1101 from the exterior of toothbrush 1000. Sealing the various components of motion assembly 1300 and power assembly 1400 within body cavity 1101 is contemplated to increase the life of motion assembly 1300 and power assembly 1400 by preventing dirt, water, or other substances from affecting motion assembly 1300 and power assembly 1400. Sealing the various components within body cavity 1101 is also contemplated as decreasing the risk of any chemicals or parts from the components adversely affecting a user of toothbrush 1000.

Head 1110 and handle 1130 may have any size and shape suitable as a toothbrush head and handle so long as they are large enough to enclose their respective cavities. The handle cavity 1131 is preferable sized and dimensioned to securely hold power source 1400. Head cavity 1111 is preferably sized and shaped to position and permit proper operation of the weight and shaft, and to position the weight well and shaft bearing of motion assembly 1300.

Neck 1120 is preferably sized and dimensioned to provide a desired overall length and flexibility to toothbrush 1000 and to contain neck cavity 1121. Neck cavity 1121 is preferably sized and dimensioned to allow flexible wire shaft 1320 to extend from the motor 1310 to the shaft bearing 1321 without having flexible wire shaft 1320 contact any of the sidewalls of neck cavity 1121. It is contemplated that the structure of neck 1120 may vary between embodiments, with the variance in structure resulting in different motions for head 1110 as weight 1330 rotates.

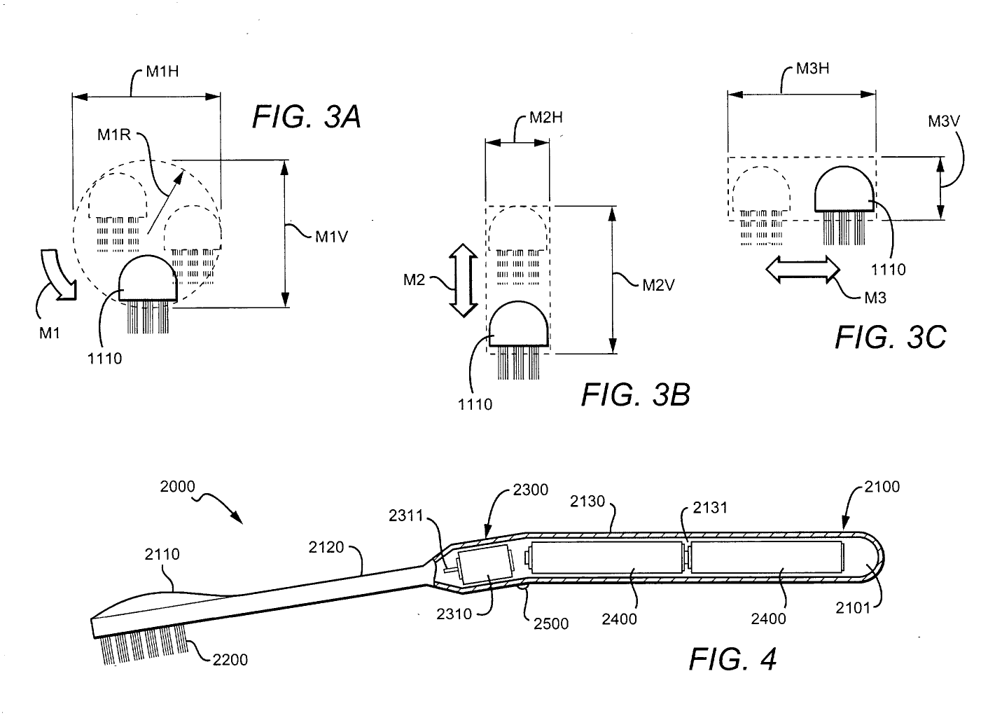

Looking at FIGS. 3A-3C, it is contemplated that proper structuring of neck 1120 may result in a circular/orbital motion of head 1110, a vertical motion, and/or a horizontal motion. In FIG. 3A, the motion M1 of head 1110 is circular/orbital in that head 1110 moves follows a path that is at least somewhat similar to the circle shown having a radius M1R, and movement distance M1V is approximately equal to its horizontal movement distance M1H. In FIG. 3B, the motion M2 of head 1110 is vertical in that vertical movement distance M2V is substantially larger than the horizontal movement distance M2H. In FIG. 3C, the motion M3 of head 1110 is horizontal in that horizontal movement distance M3H is substantially larger than the vertical movement distance M3V.

Bristles 1200 are preferably permanently mounted to head 1110. It is contemplated, however, that bristles 1200 may be removeably mounted to head 1110 for ease of replacement. Similarly, head 1110 and neck 1120 may be removeably coupled to each other and/or neck 1120 may be removeably coupled to body 1130. Motion assembly 1300 is used to convert energy from power source(s) 1400 to movement of head 1110. In the preferred embodiment, the motor spindle 1311 is coupled to flexible wire shaft 1320 by a polyimide or other polymer tube couple 1312 such that when power is applied to motor 1310, spindle 1311 and flexible wire shaft 1320 rotate. Weight 1330 is mounted to flexible wire shaft 1320 such that flexible wire shaft 1320 does not pass through the center of weight 1330. FIG. 2 illustrates the motion of weight 1330 as flexible wire shaft 1320 rotates to cause the head to move as illustrated in FIGS. 3A-3C. Weight well 1331 permits weight 1330 to rotate without contacting any of the side walls of head cavity 1111 or body cavity 1101. The movement caused by rotation of weight 1330 is transferred to head 1110 via shaft bearing 1321. Shaft bearing 1321 is preferably chosen to minimize the noise generated by movement of flexible wire shaft 1320 and weight 1330. Although fixed in regard to shaft 1320, weight 1330 is rotatably mounted within toothbrush 1000 as it is mounted in a manner that permits it to rotate within the toothbrush.

It is contemplated that, for improved motion of head 1110, distance D1 should be less than distance D2. It is also contemplated that having distance D2 be at least 50 mm or 2inches inches may prove advantageous. Similarly, distance D1 may be less than 12.5mm or 0.5inches. It is also contemplated that it may be advantageous for the ratio of D2 to D1 to be at least 4:1or 500 %. It is also contemplated that it may be advantageous to minimize the distance between weight 1330 and shaft bearing 1321 in order to maximize the transfer of motion of weight 1330 to head 1110. In some instances, shaft bearing 1321 may be positioned between weight 1330 and motor 1310.

It is also contemplated that making shaft 1320 and coupling 1312 flexible facilitates in transferring and concentrating energy in the head of the brush by (in conjunction with neck 1120) isolating the orbital energy of the brush head from the mass of the handle, drive, and batteries. In some embodiments, the amount of flexibility of in shaft 1320 and coupling 1312 may vary, although it is preferred that as shaft 1320 is made stiffer, coupling 1312 is made more flexible. Similarly, it is preferred that as coupling 1312 is made stiffer, shaft 1320 is made more flexible.

Power source 1400 is preferred to comprise two AAA batteries. However, alternative embodiments may use different types of batteries or capacitors as power source 1400. It is preferred that the choice of power source be made such that the amount of time that power source 1400 is able to adequately power motor 1310 is at least 8 hours, and more preferably at least 9-12 hours. If usage is about 2 minutes a day, the life of the brush would be approximately 8 months for an 8 hour battery life, and 9 -12 month for a 9-12 hour life.

Control assembly 1500 may comprise a simple switch used to complete or break an electrical connection between power source 1400 and motor 1310. However, alternative embodiments may use more complex means of motor control.

FIG. 4 illustrate one alternate embodiment having an angled neck. As shown in FIG. 4, toothbrush 2000 comprises body 2100, bristles 2200, motion assembly 2300, power source(s) 2400, and control assembly 2500. Body 2100 comprises head 2110, neck 2120, and handle 2130. Head 2110 is the portion of body 2100 to which bristles 2200 are mounted. Neck 2120 is the portion of body 2100 that couples head 2110 to handle 2130. Handle 2130 is the portion of body 2100 that is adapted to be gripped by someone using toothbrush 2000. Body 2100 also comprises body cavity 2101 that is subdivided into cavities corresponding to head 2110, neck 2120, and handle 2130. The only sub-cavity of body cavity 2101 shown is handle cavity 2131. Motion assembly 2300 comprises motor 2310 and motor spindle 2311, as well as a coupler, flexible wire shaft, shaft bearing, weight, and weight well which are similar to those shown in FIG. 1. Power source 2400 comprises two AAA batteries. Control assembly 2500 comprises the switches and circuitry used to control the use of motor 2310.

The use of either toothbrush 1000 or 2000 can be described as using an electric toothbrush comprising causing an eccentric weight located within a head of the toothbrush to rotate and, while the weight is rotating, using the toothbrush to brush teeth. More specifically, causing an eccentric weight to rotate comprises electrically connecting an electric motor to a power source so as to cause a motor spindle to rotate, the motor spindle causing a shaft to rotate, the shaft causing the eccentric weight to rotate.

Thus, specific embodiments and applications of disposable electronic toothbrushes have been disclosed. It should be apparent, however, to those skilled in the art that many more modifications besides those already described are possible without departing from the inventive concepts herein. In particular, it is contemplated that any form of toothbrush utilizing a rotating eccentric weight located in or near the bristle portion of the toothbrush may be used so long as the choice of structure and materials does not prevent rotation of the weight from generating acceptable movement of the bristles. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A toothbrush having a head and a handle, and an eccentrically moveable weight disposed in or near the head.

2. The toothbrush of claim 1 further comprising a motor that drives the weight, the motor disposed in the handle.

3. The toothbrush of claim 2 wherein the center of mass of the weight is positioned farther from the motor than from the head.

4. The toothbrush of claim 2 wherein the motor is electrically operated.

5. The toothbrush of claim 2 wherein the motor is spring operated.

6. The toothbrush of claim 2 further comprising a flexible link mechanically coupling the motor and the weight.

7. The toothbrush of claim 6 wherein the motor rotates a shaft about which the weight travels.

8. The toothbrush of claim 7 wherein the weight rotates with the shaft, but has a mass distribution that is not symmetrical about the shaft.

9. The toothbrush of claim 1 wherein the toothbrush further comprises an elongated neck and a motor assembly wherein the neck couples the head to the handle, and wherein the motor assembly comprises a motor positioned within the handle, a rotatable elongated shaft coupled to the motor and extending through the neck from the handle to the head, and an eccentric weight, the weight being coupled to the shaft.

10. The toothbrush of claim 9 wherein the motor comprises a drive shaft, and the elongated shaft is coupled to the drive shaft by a flexible connecting member.

11. The toothbrush of claim 10 wherein the flexible connecting member comprises a polyimide tube.

12. The toothbrush of claim 1 further comprising a motor, wherein the head forms an end of the toothbrush, and a first distance between the center of mass of the weight and the motor is greater than a second distance between the center of mass of the weight and the head end of the toothbrush, wherein the ratio between the first distance and the second distance is at least 4.

13. The toothbrush of claim 1 further comprising a motor, wherein the distance between the center of mass of the weight and the motor is greater than 50 mm.

14. The toothbrush of claim 1 further comprising a motor, wherein the head forms an end of the toothbrush, and the distance between the center of mass of the weight and the head end of the toothbrush is less than 12.5 mm.

15. The toothbrush of claim 1 wherein toothbrush comprises a first assembly removably coupled to a second assembly, with the head being part of the first assembly.

16. The toothbrush of claim 1 wherein the toothbrush further comprises:
a handle;
an elongated neck; and
a motor assembly; wherein
the neck couples the head to the handle with the head positioned at a first end of the neck as an end of the toothbrush and with the handle positioned at a second end of the neck;
the motor assembly comprises a motor positioned within the handle, a motor drive shaft; an elongated shaft coupled to the motor drive shaft by a flexible tube and extending through the neck from the handle to the head, and the eccentric weight, the weight being coupled to the shaft;
a first distance between the center of mass of the weight and the motor is at least four times greater than a second distance between the center of mass of the weight and the head end of the toothbrush; and wherein
the first distance is at least 50mm and the second distance is less than or equal to 12.5mm.

17. The toothbrush of claim 1, wherein the toothbrush comprises:
a handle having a head, a neck, a handle, and a cavity within the handle, the cavity having a weight well positioned within the head; and
a motion assembly having a motor, motor spindle, flexible coupler, flexible wire shaft, shaft bearing, and weight; wherein
the head comprises bristles and is coupled to the handle via the neck;
the handle is adapted to be gripped by a person;
the motor spindle is part of the motor and is coupled to the wire shaft by the flexible coupler;
the wire shaft extends from the motor, through the neck, and into the head where an end of the shaft is received by the shaft bearing;
the weight is eccentrically mounted to the wire shaft;
the motion assembly is positioned within the cavity, with the motor in the handle and the weight in the weight well;
the spindle, shaft, and weight adapted to rotate within the handle cavity without contacting the handle.
